(19) United States
(12) Patent Application Publication
(10) Pub. No.: US 2009/0096412 A1
(43) Pub. Date: Apr. 16, 2009

(54) INDUCTIVE CHARGING DEVICE

(76) Inventor: CHUAN-PAN HUANG, Tainan City (TW)

Correspondence Address: J.C. Patents, Suite 250, 4 Venture, Irvine, CA, 92618, US

(21) Appl. No.: 11/870,390

(22) Filed: Oct. 10, 2007

(51) Int. Cl. H02J 7/00

(52) U.S. Cl. 320/108

(57) ABSTRACT

An induction charging device includes a charging pad and a battery set. The charging pad is composed of an inverting oscillating circuit connected with an emitting induction coil, and a charging room having the inside, the outside, the top or the bottom of its room wall installed with the emitting induction coil. The battery set has a main body installed with a charging system, which has a rectifying/filtering circuit, a charging control circuit and a receiving induction coil, characterized by having the receiving induction coil set inside or outside the main body of the battery set to receive electromagnetic field generated by the emitting induction coil to enable two ends of the receiving induction coil created with voltage to drive the charging system to proceed with induction charging.

### BACKGROUND OF THE INVENTION

1. Field of the Invention

This invention relates to an inductive charging device, particularly to one having its battery set provided with a charging system including a receiving induction coil disposed outside or inside a main body of the battery set. Via inducing an electromagnetic field generated by an emitting induction coil of an inverting oscillating circuit, the receiving induction coil can be created with voltage to drive the charging system to inductively charge a battery.

2. Description of the Prior Art

A first conventional non-contact charging device disclosed in Taiwan Patent No 311775 is composed of a charger and a battery set. The charger is provided with a power supply circuit employed to supply a rated DC voltage, an oscillating circuit connected with the power supply circuit to convert the DC voltage into DC pulse voltage, a driving circuit connected with the oscillating circuit to make a magnification of the DC pulse voltage, and a primary induction coil connected with the driving circuit so as to obtain the DC pulse voltage of the driving circuit for transmitting electrical energy via electromagnetic induction. The battery set is provided with a secondary induction coil for being induced to receive electrical energy, a rectifying circuit connected with the secondary induction coil to keep the voltage gained by the secondary induction coil rectified, a filtering circuit connected with the secondary induction coil to keep the voltage gained by the secondary induction coil filtered to become a steady DC voltage, and a battery also connected with the circuit of the secondary induction coil to save the electrical energy received by the secondary induction coil for being used as power supply. In using, if the battery is to be charged, put the secondary induction coil of the battery set correspondingly close to the primary induction coil of the charger to enable the electrical energy of the charger transmitted to the battery, achieving a purpose of charging.

As disclosed in Taiwan Patent No. M295407, a second conventional non-contact charging device for a wired or wireless microphone includes a charging circuit that is disposed in a main body of the microphone, provided with an induction coil and connected with a battery. When the induction coil is induced by a foreign electromagnetic wave, it can create a current to charge a battery to supply power for the microphone. The electromagnetic wave is generated by a high frequency circuit installed in a charging pad. The high frequency circuit is provided with a rectifier used to rectify an input DC, and a transformer passed by the rectified DC to induce an induction coil to create a high frequency.

The second conventional non-contact charging device has the induction coil in the charging circuit, which is connected with the battery to induce high frequency from the induction coil of the transformer of the rectifier in the high frequency circuit, for charging.

And, as disclosed in Taiwan patent No. M314967, a third conventional non-contact charging pad for a global positioning receiver is provided with a main base, an accommodating cavity formed inside the main base for being placed with the global positioning receiver, and a power supply module installed inside the main base near the accommodating cavity. The global positioning receiver includes an inductive charging circuit disposed in a groove of the accommodating cavity. The power supply module is wired with an exterior power supply, provided with a high frequency circuit utilized to create electromagnetic waves that wirelessly transmit energy to an inductive charging circuit of the global positioning receiver for carrying out charging. The inductive charging circuit is composed of an induction coil, a rectifying circuit and a charging control circuit.

The third conventional non-contact inductive charging circuit set in the global positioning receiver is provided with the power supply module wired to an exterior power supply. The power supply module includes a high frequency circuit used for generating electromagnetic waves that wirelessly transmit energy to the induction coil, the rectifier and the charging control circuit of the inductive charging circuit of the global positioning receiver sequentially to carry out charging.

As described previously, all of the three conventional non-contact charging systems have their charging circuits provided with an induction coil for being induced by the charger or the electromagnetic waves created by the induction coil of the high frequency circuit to proceed with charging. They are characterized that their induction coils are integrally combined with the current circuit of the charging circuit. However, the present invention has its induction coil disposed outside the main body of the battery, with a different interior structure, achieving an unlike ability of receiving electromagnetic field.

### SUMMARY OF THE INVENTION

The objective of this invention is to offer an inductive charging device without letting a battery contact with an inverting oscillating circuit.

The inductive charging device of the present invention is provided with a battery set having a receiving induction coil installed outside or inside its main body to receive a maximum electromagnetic field generated by an emitting induction coil of an inverting oscillating circuit, so that two ends of the receiving induction coil are created with voltage to provide for a charging system to obtain a charging voltage drop to charge a battery.

The characteristics of the present invention are described as below.

1. The battery set is provided with a main body that is installed with the receiving induction coil outside or inside it.

2. The charging system in the main body of the battery set is provided with a rectifying/filtering circuit and a charging control circuit, connected with the receiving induction coil. Via inducing the electromagnetic field generated by the emitting induction coil of the inverting oscillating circuit, two ends of the receiving induction coil can be created with voltage to drive the charging system to carry out inductive charging.

### BRIEF DESCRIPTION OF DRAWINGS

This invention is better understood by referring to the accompanying drawings, wherein:

FIG. 1 is a perspective view of a first embodiment of a charging pad in a preferred embodiment of an inductive charging device in the present invention;

FIG. 2 is a perspective view of a second embodiment of the charging pad in the preferred embodiment of an inductive charging device in the present invention;

FIG. 3 is a perspective view of a third embodiment of the charging pad in the preferred embodiment of an inductive charging device in the present invention;

FIG. 4 is a partial exploded view of an inverting oscillating circuit in the preferred embodiment of an inductive charging device in the present invention;

FIG. 5 is a perspective view of a first embodiment of a battery set in the preferred embodiment of an inductive charging device in the present invention;

FIG. 6 is a perspective view of a second embodiment of the battery set in the preferred embodiment of an inductive charging device in the present invention; and

FIG. 7 is a block diagram of a charging system in the preferred embodiment of an inductive charging device in the present invention.

### DETAILED DESCRIPTION OF THE PREFERRED EMBODIMENT

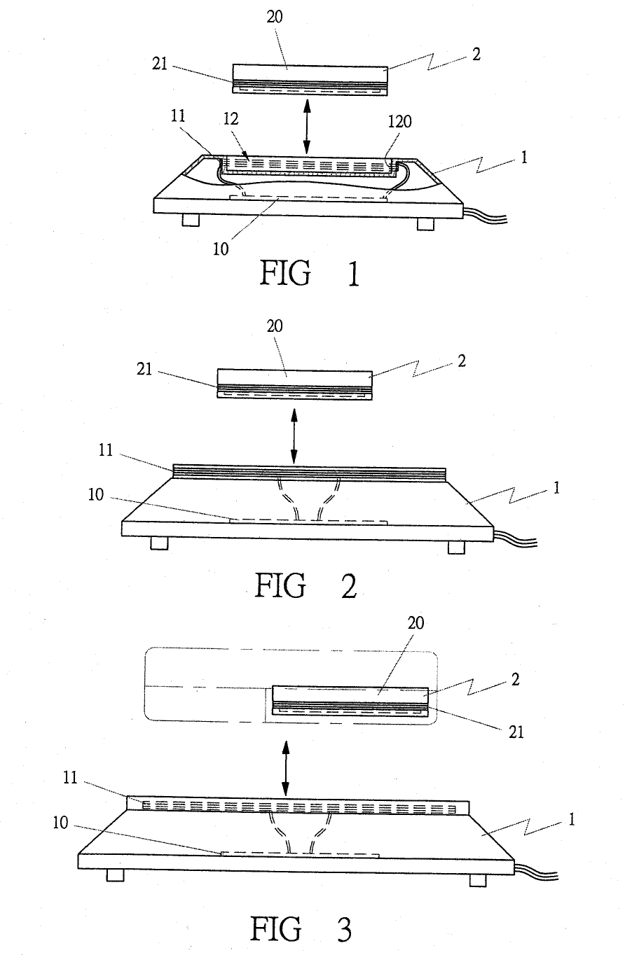

As shown in FIGS. 1 and 2, a preferred embodiment of an inductive charging device in the present invention is composed of a charging pad 1 and a battery set 2.

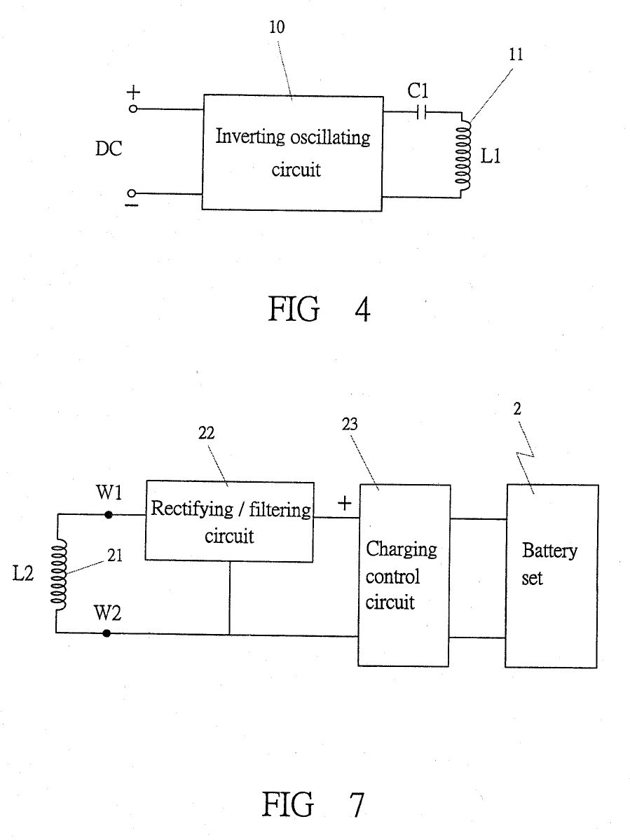

The charging pad 1 is provided with an inverting oscillating circuit 10 (as shown in FIG. 4) installed inside it, an emitting induction coil 11 connected with the inverting oscillating coil 10, and a charging room 12 for disposing the emitting induction coil 11 inside a room wall 120 of the charging room 12 (a first embodiment as shown in FIG. 1), outside the groove wall 120 of the charging groove 12 (a second embodiment as shown in FIG. 2), or at its top or its bottom (a third embodiment as shown in FIG. 3). The emitting induction coil 11 can be made of conductive copper lines or printed conductive sheets, able to generate an appropriate electromagnetic field after having the inverting oscillating circuit 10 of the charging pad 1 being activated.

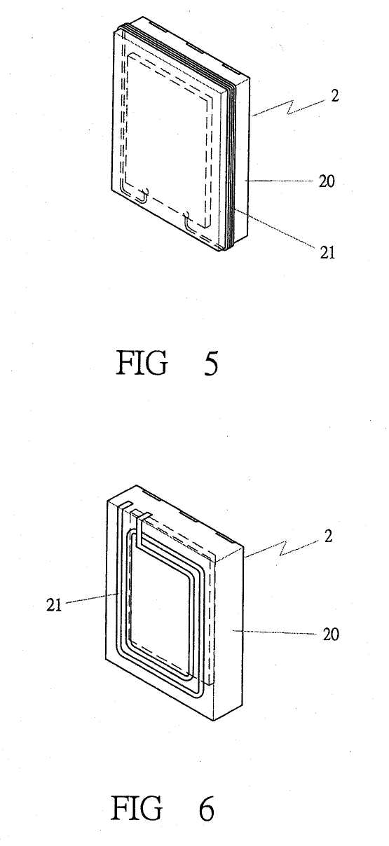

The battery set 2 is provided with a main body 20, and a receiving induction coil 21 placed outside the main body 20 (a first embodiment as shown in FIG. 5) or inside the main body 20 (a second embodiment as shown in FIG. 6). The receiving induction coil 21 can be as well made of conductive copper lines or printed conductive foils. As shown in FIG. 7, a charging system installed in the battery set 2 is provided with a rectifying/filtering circuit 22 and a charging control circuit 23 that is connected with the receiving induction coil 21.

During the charging process, the emitting induction coil 11 of the inverting oscillating circuit 10 creates electromagnetic field in the charging room 12 to induce the receiving induction coil 21 which can obtain the maximum electromagnetic field as it has been emitted by the emitting induction coil 11, so as to keep two ends of the receiving induction coil 21 created with voltage to drive the charging system of the battery set 2 to inductively charge a battery. Therefore, the present invention is not only a wireless inductive charging device, but also able to maintain an excellent charging voltage to have a great charging capability.

While the preferred embodiment of the invention has been described above, it will be recognized and understood that various modifications may be made therein and the appended claims are intended to cover all such modifications that may fall within the spirit and scope of the invention.

What is claimed is:

1. An inductive charging device comprising:
a charging pad provided with an inverting oscillating circuit that is connected with an emitting induction coil, a charging room for accommodating said emitting induction coil;
a battery set provided with a main body which is placed with a charging system provided with a rectifying/filtering circuit, a charging control circuit and a receiving induction coil; and
characterized by having said receiving induction coil installed in said main body of said battery set to receive an electromagnetic field generated by said emitting induction coil to enable two ends of said receiving induction coil created with voltage to drive said charging system to carry out charging.

2. The inductive charging device as claimed in claim 1, wherein said emitting induction coil is disposed inside a room wall of said charging groove.

3. The inductive charging device as claimed in claim 1, wherein said emitting induction coil is disposed outside said room wall of said charging groove.

4. The inductive charging device as claimed in claim 1, wherein said emitting induction coil is installed at a bottom of said charging room.

5. The inductive charging device as claimed in claim 1, wherein said emitting induction coil is installed at a top of said charging room.

6. The inductive charging device as claimed in claim 1, wherein said receiving induction coil is disposed at an outside of said main body of said battery set.

7. The inductive charging device as claimed in claim 1, wherein said receiving induction coil is disposed inside said main body of said battery set.
